(19) United States
(12) Patent Application Publication
(10) Pub. No.: US 2006/0106737 A1
(43) Pub. Date: May 18, 2006

(54) CALCULATION OF REAL TIME INCREMENTAL EMISSIONS COST

(75) Inventors: Richard Gomer, Carson City, NV (US); Bryan Holzbauer, Gardnerville, NV (US); Scott Williams, Minden, NV (US); Shane Jenkins, Minden, NV (US); James A. Maxson, Minden, NV (US); Stephen Kwan, Minden, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/904,489

(22) Filed: Nov. 12, 2004

(51) Int. Cl. G06F 17/00

(52) U.S. Cl. 705/400

(57) ABSTRACT

A method of generating emission curves over a range of load points includes obtaining current measurements from a respective sensor. The current measurements are validated and a plurality of emission curves using predefined inputs for each load point are generated. The plurality of emission curves includes an emission design curve and a corresponding real time incremental emission curve. Each corresponding real time incremental emission curve and emission design curve are validated to generate a validated emission curve. An incremental emission cost curve using each validated emission curve for each type of emission is generated. Each incremental emission cost curve is summed if there is more than one incremental emission cost curve.

### BACKGROUND OF THE INVENTION

A hydrocarbon fuel can be burned in a combustor or combustion system (hereinafter “combustion system”), such as, but not limited to, boilers, furnaces, combustion gas turbines or fossil combustors, to produce heat to raise the temperature of a fluid. Various governmental entities have imposed limits for combustion byproducts/products that operators of combustion systems must fall within for compliance with environmental regulations and design constraints. For the combustion system to operate efficiently and to produce an acceptably “complete” combustion (a combustion where combustion byproducts/products fall within the limits imposed by environmental regulations and design constraints), individual burners of the combustion system should be operating cleanly and efficiently. Further, post-flame combustion control systems should be properly balanced and adjusted so that the combustion system operates in compliance with environmental regulations and design constraints.

Emissions of unburned carbon, nitric oxides (in this application meaning NO, NO₂, NOx), carbon monoxide (CO), carbon dioxide (CO₂), sulfur oxide (SOx), ash, particulate matter, or other byproducts commonly are monitored to ensure compliance with environmental regulations. As used herein and in the claims, the term nitric oxides shall include nitric oxide (NO), nitrogen dioxide (NO₂), and nitrogen oxide (NOx, where NOx is the sum of NO and NO₂). The monitoring of emissions heretofore has been done, by necessity, on the aggregate emissions from the combustion system. When a particular combustion byproduct is produced at unacceptably high concentrations, the combustion system should be adjusted to restore proper operations.

Utilities typically use static, emission design curves to illustrate a trend of emission production of a combustor. While this methodology captures the gross trend of emissions versus megawatt (MW) power output, the static design curve does not reflect all of the real-time variance in emissions. In particular, the emissions design curve does not account for changes in the shape of the emissions curve itself. Both the magnitude and shape of the curve change as conditions at the utility plant change, such as changes in, for example, boiler cleanliness, ambient temperature, fuel quality, operating procedure, equipment maintenance, amongst numerous other changes.

Producing emissions such as NOx actually increases the cost of how much it actually costs to generate power. More specifically, the EPA gives each utility a certain number of NOx credits that the utility uses when it start to produce excess NOx. Emissions such as NOx is a traded commodity on the open market and the price varies day-to-day. When the utility has used all the EPA allotted credits for NOx production, the utility can go on the market and purchase NOx credits to compensate and charge more for the produced electricity to cover the cost of purchasing the additional NOx credits. Therefore, incorporating the cost of emissions with the traditional cost of generating electrical power (e.g., fuel costs) can more accurately predict how much it actually costs to produce electrical power in order to determine profitability.

Accordingly, there is a desire to create a real time emissions cost curve to improve the accuracy of the incremental cost curves, which will in turn make generation decisions made by the customer even more profitable.

### BRIEF DESCRIPTION OF THE INVENTION

The above discussed and other drawbacks and deficiencies are overcome or alleviated by a method of generating emission curves over a range of load points. The method includes obtaining current measurements from a respective sensor. The current measurements are validated and a plurality of emission curves using predefined inputs for each load point are generated. The plurality of emission curves includes an emission design curve and a corresponding real time incremental emission curve. Each corresponding real time incremental emission curve and emission design curve are validated to generate a validated emission curve. An incremental emission cost curve using each validated emission curve for each type of emission is generated. Each incremental emission cost curve is summed if there is more than one incremental emission cost curve.

In an alternative embodiment, one or more computer-readable media having computer-readable instructions thereon which, when executed by a computer, cause the computer to: obtain current measurements from a respective sensor; validate the current measurements; generate a plurality of emission curves using predefined inputs for each load point, the plurality of emission curves including an emission design curve and a corresponding real time incremental emission curve; validate each corresponding real time incremental emission curve and emission design curve to generate a validated emission curve; and generate an incremental emission cost curve using each validated emission curve for each type of emission.

In yet another embodiment, a system for generating emission curves over a range of load points is disclosed. The system includes: means for obtaining current measurements from a respective sensor; means for validating the current measurements; means for generating a plurality of emission curves using predefined inputs for each load point, the plurality of emission curves including an emission design curve and a corresponding real time incremental emission curve; means for validating each corresponding real time incremental emission curve and emission design curve to generate a validated emission curve; and means for generating an incremental emission cost curve using each validated emission curve for each type of emission.

The above-discussed and other features and advantages of the present disclosure will be appreciated and understood by those skilled in the art from the following detailed description and drawings.

### BRIEF DESCRIPTION OF THE FIGURES

The following description of the figures is not intended to be, and should not be interpreted to be, limiting in any way.

FIG. 1 is a flowchart illustrating a method to generate a real time emissions cost curve to improve the accuracy of the incremental cost curves and validation of the same in accordance with an exemplary embodiment;

FIG. 2 is a graph illustrative of validation of each emissions break point against tolerance bounds for that emission in accordance with an exemplary embodiment;

FIG. 3 is a graph comparing an emission design curve with a real-time incremental emission curve for validation of the latter; in accordance with an exemplary embodiment,

FIG. 4 is a graph of all real-time incremental emission cost curves summed together to create a total incremental emissions cost curve illustrating emissions cost throughout a full megawatt range; and

FIG. 5 is a diagram of exemplary hardware associated with the methodology of FIG. 1.

### DETAILED DESCRIPTION OF THE INVENTION

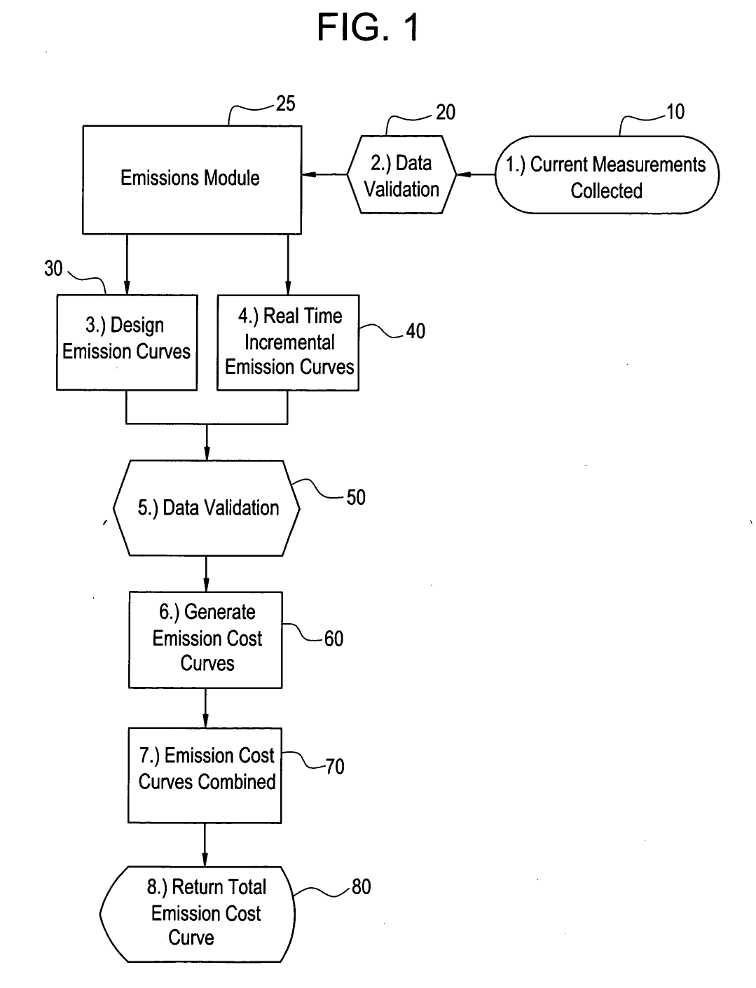

Referring to FIG. 1, at block 10, current measurements are collected from one or more corresponding sensors configured to measure respective setpoint data. The setpoint data includes, but is not limited to, for example: excess oxygen; coal quality; mill biases; fan biases; burner damper positions; overfire air damper positions; furnace pressure; windbox pressure drop; economizer gas exit temperatures; air heater air exit temperature; superheat and reheat steam temperature and pressure; burner tilts; ambient temperature and pressure; or averaged emission from a preceding time step.

At block 20, the current measurements are validated and replaced if necessary with appropriate values. For example, if a sensor is damaged, the current measurements can be replaced with a last known good value or a default value. The current measurements are then provided to an emissions module indicated generally at block 25.

At block 30, emission design curves are generated using predefined inputs for a given emission at each megawatt load point. At block 40, real time incremental emission curves are created using a number of methods which include, but are not limited to, using curve fitting based on historical data and current measurements, design curves offset with current emission measurements, artificial intelligence or physics based models. As used herein, “real time” means the actual time during which something takes place (e.g., the computer may partly analyze the data in real time, or in other words, as the data is received). No matter what method or combination of methods are used to produce real time incremental emission curves, the methods will be able to produce an emission curve over the full range of megawatt outputs.

At block 50, each real time incremental emission curve created at block 40 from the emissions module 45 is checked for positive coefficients and verified against a corresponding emissions design curve created at block 30. If the two curves are within defined tolerances, the real time incremental emission curve created using the emissions module is considered good and is forwarded to block 60 as a valid real time incremental emission curve. If the emissions modules predicted real time incremental emission curve is out of tolerance, the emission design curve created at block 30 is returned and forwarded to block 60 as being more valid that the real time incremental emission curve.

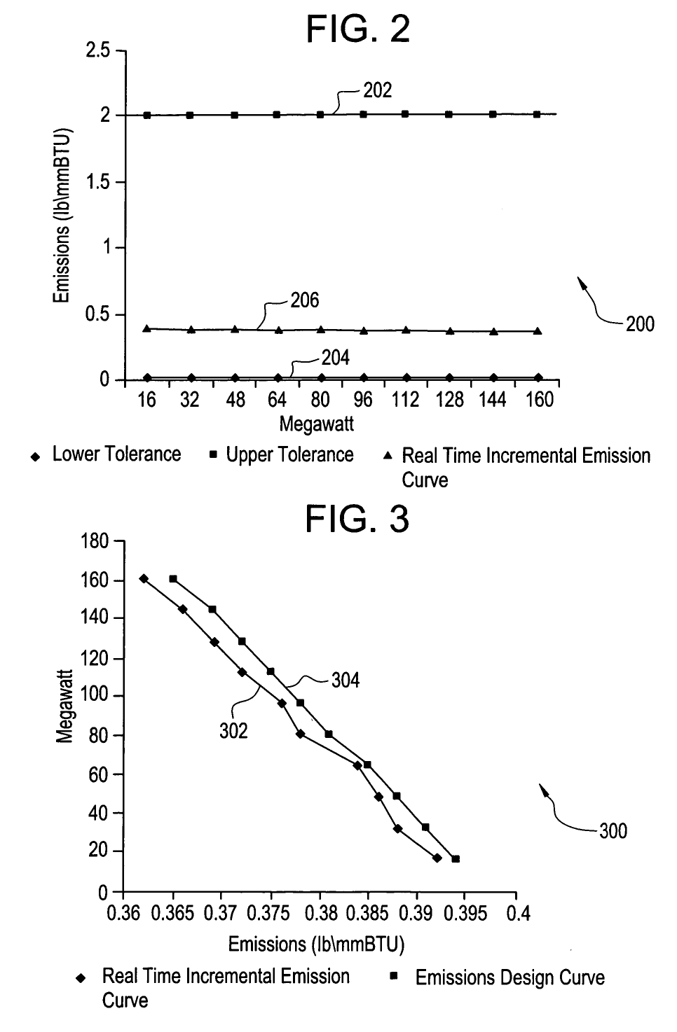

Data validation is required for each real time incremental emission curve to prove the emission curve is valid. Referring to FIG. 2, a first check includes validating each emissions breakpoint against the tolerance bounds for that emission. If any of the breakpoints are outside the bounds, the emission design curve of block 30 is used as a replacement. FIG. 2 illustrates a graph 200 of emission versus megawatts. A first curve 202 illustrates an upper tolerance curve depicting the upper bounds, while a second curve 204 illustrates a lower tolerance curve depicting the lower bounds. A third curve 206 intermediate first and second curves 202 and 204, respectively, illustrates a generated emissions module curve within the upper and lower bounds.

Referring now to FIG. 3, after validating each emission breakpoint or load point against the tolerance bounds for emission, the emissions module calculated real time incremental emission curve of block 40 is compared with the emission design curve of block 30 indicated generally at graph 300 for that emission. Graph 300 depicts megawatt load points versus emission. In particular, graph 300 illustrates the emissions module calculated real time incremental emission curve of block 40 indicated at 302, while the emission design curve of block 30 is indicated at 304. One factor to check includes verifying that a trend of curve 302 is correct relative to curve 304. More specifically, verifying the trend includes verifying that a slope of both curves is substantially the same or has the same negative or positive slope (e.g., right sign).

In an exemplary embodiment, one method to assess that the slopes are either both positive or negative includes creating appropriate curve fitting of empirical data, such as parabolic curve fits, for example, for both curves 302, 304 and verifying that the sign of the first and second order coefficients are the same, e.g.,
Emissions_{design}=(A×MW²+B×MW+C)
Emissions_{RealTime}=(A′×MW²+B′×MW+C′)
If ((((A>0) and (A′<0)) or ((A<0) and (A′>0))) or (((B>0) and (B′<0)) or ((B<0) and (B′>0))) then

logic=false,

else

logic=true.

If the logic variable above is “false”, the real time incremental emission curve 302 should be rejected and the emission curve 304 is used as a replacement. It is contemplated that the emissions curve include, but is not limited to, NOx, SOx, ash, carbon monoxide CO, and mercury, for example.

At block 60, each emission curve is used to generate an emission cost curve. In particular, incremental emission cost curves are created using corresponding real time incremental emission curves of block 40. For example, an incremental NOx cost curve may be produced by using the following formula:
Incremental NOx Cost($/MW−hr)=NOx Cost Rate($/ton)×{Heat Input(MBtu/hr)×d/dMW[NOx Production(ton/MBtu)]+NOx Production(ton/MBtu)×d/dMW[Heat Input(MBtu/hr)]}
where “Heat Input” is calculated from a heat rate of a fuel being used to produce power at a given megawatt.

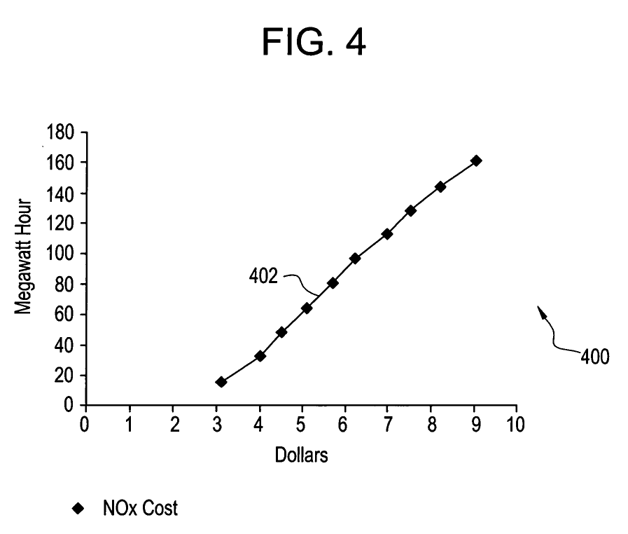

Referring now to FIG. 4, a graph 400 of megawatt out versus NOx cost is illustrated. More specifically, a NOx cost curve 402 depicts the incremental emission cost of NOx emissions at a range of megawatt outputs form zero to 180 megawatt hours. It will be noted that since the NOx production varies with load, the entire NOx cost curve 402 must be determined over the operating load range to calculate the incremental NOx cost.

After all of the incremental emissions cost curves, such curve 402 for cost of NOx emissions, for example, have been produced, all of the incremental emissions cost curves are summed together to create a total incremental emissions cost curve indicated at block 70. This will improve the accuracy of the incremental cost curves, which will in turn make generation management decisions made by the customer even more profitable.

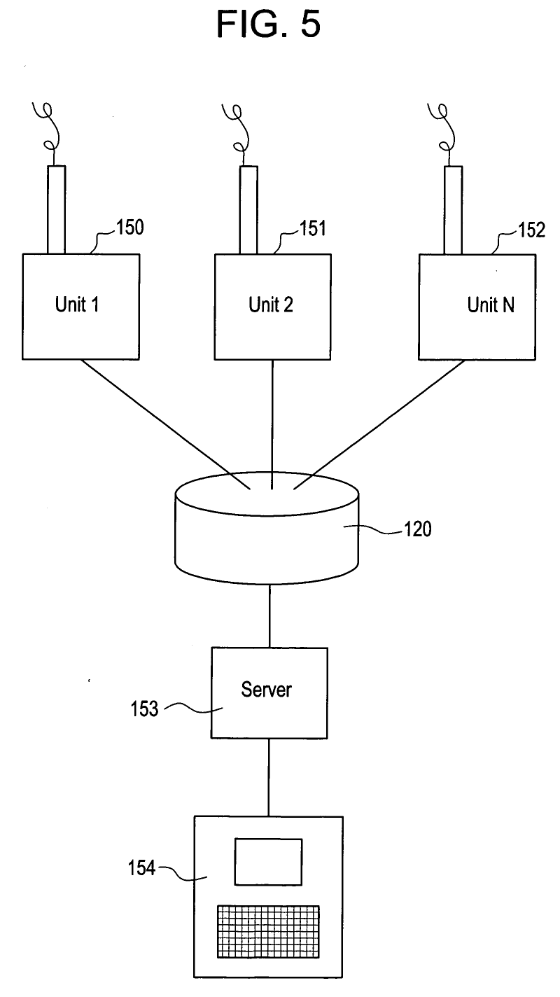

At block 80, the total emissions cost curve is returned after combining the various emission cost curves of block 70. Block 80 may further include displaying the total emissions cost curve. In an exemplary embodiment, the displaying of block 80 may include using a display device indicated at 154 in FIG. 5.

For a user or a power company acting as a seller, a number of advantages accrue from the above, some of which are discussed below. For example, instead of relying on a human generated best guess to forecast reasonable emissions and associated costs at any megawatt load point in a range of megawatt load points, and thus for the power company to be economically successful in estimating such emissions and costs, real time incremental emission curves can be relied on to generate real time incremental cost curves for that emission instead. This leads to more accurate and thus more successful estimates of total emissions and cost associated therewith. A number of methods can be used which include, but are not limited to, using curve fitting based on historical data and current measurements, design curves offset with current emission measurements, artificial intelligence or physics based models. The selected methodology for the emissions module will be used to produce emission curves at different megawatt load points for a turbine. The emissions module will accept a number of inputs at different megawatt load points to predict emissions at each megawatt load point using current measurements for each input into the emissions module. Using each emission predicted point the points will be combined to create a real time incremental emission curve for the full range of megawatt load points for the turbine. Thus, one advantage accrued by the above disclosure is to create a predicted real time incremental emission curves over the full range of megawatt load points on demand based on current measurements and/or historical data.

As shown in FIGS. 1-5, the present system, methods, and apparatus, may be embodied as software and/or hardware in a computer system as a software program or product code for any desired number of power generation units (150-152) having a user interface 154 and having access to a historical data, current measurement and setpoint database 120. The embodiments described herein are is not limited to any particular type of fuel source or type of power generation unit or plant, including nuclear, fossil fuel plants including oil and gas plants, geothermal, solar, hydroelectric, wind power or other fuel source.

FIG. 5 illustrates an example of a suitable computing system environment in which the methods and apparatus described above and/or claimed herein may be implemented. The computing system environment is only one example of a suitable computing environment and is not intended to suggest any limitation as to the scope of use or functionality of the invention. Neither should the computing environment shown in FIG. 4 be interpreted as having any dependency or requirement relating to any one or combination of components illustrated in the exemplary operating environment in FIG. 5.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, personal computers, server computers, hand-held or laptop devices, multiprocessor systems, microprocessor-based systems, network PCs, minicomputers, mainframe computers, distributed computing environments that include any of the above systems or devices.

The methods described above and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different power plants or different power generator units (150-152) where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus of described above and/or claimed herein. Further, any storage techniques used in connection with the methods and apparatus described above and/or claimed herein may invariably be a combination of hardware and software.

While the methods and apparatus described above and/or claimed herein have been described in connection with the preferred embodiments and the figures, it is to be understood that other similar embodiments may be used or modifications and additions may be made to the described embodiment for performing the same function of the methods and apparatus described above and/or claimed herein without deviating therefrom. Furthermore, it should be emphasized that a variety of computer platforms, including handheld device operating systems and other application specific operating systems are contemplated, especially given the number of wireless networked devices in use.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A method of generating emission curves over a range of load points, the method comprising:
obtaining current measurements from a respective sensor;
validating the current measurements;
generating a plurality of emission curves using predefined inputs for each load point, the plurality of emission curves including an emission design curve and a corresponding real time incremental emission curve;
validating each corresponding real time incremental emission curve and emission design curve to generate a validated emission curve; and
generating an incremental emission cost curve using each validated emission curve for each type of emission.

2. The method of claim 1, further comprising:
summing each incremental emission cost curve to generate a total emissions cost curve if there is more than one incremental emission cost curve.

3. The method of claim 1, wherein the emission design curve is generated based on predefined inputs for emission at each megawatt load point and the corresponding real time incremental emission curve is generated over a full range of megawatt outputs by at least one of: offsetting the emission design curve with current emission measurements; using curve fitting based on historical data and the current measurements; artificial intelligence, and physics based models.

4. The method of claim 1, wherein the real time incremental emission curve is generated as the validated emission curve if valid.

5. The method of claim 1, wherein the emission design curve is generated as the validated emission curve if valid and the real time incremental emission curve is invalid.

6. The method of claim 1, wherein each incremental emission cost curve is produced by using the following formula:
Incremental Emission Cost($/MW−hr)=Emission Cost Rate($/ton)×{Heat Input(MBtu/hr)×d/dMW[Emission Production(ton/MBtu)]+Emission Production(ton/MBtu)×d/dMW[Heat Input(MBtu/hr)]}
where heat input is calculated from a heat rate of a fuel being used to produce power at a given load point.

7. The method of claim 1, wherein validation of the current measurements includes validating each emission load point against predefined tolerance bounds for that emission.

8. The method of claim 1, wherein the real time incremental emission curve is validated against the emission design curve by checking a trend of slopes for each curve.

9. The method of claim 8, wherein checking the trend of slopes for each curve includes creating curve fits for both curves and checking whether a sign of all higher order polynomial coefficients are the same.

10. The method of claim 9, wherein when the sign is the same, the real time incremental emission curve is generated as the validated emission curve, if not, the emission design curve is returned.

11. The method of claim 1, wherein the validating the current measurements includes replacing a current measurement with an appropriate value if necessary.

12. The method of claim 11, wherein the appropriate value includes at least one of a last known good value and a default value.

13. The method of claim 1, wherein creating the real time incremental emission curve includes:
passing all inputs for a corresponding load point through an emissions module; and
generating a predicted value of emission for the corresponding load point for all load points in a selected megawatt load point range.

14. The method of claim 13, wherein the inputs to the emissions module include setpoints derived from a corresponding design curve that is offset according to values of the current measurements.

15. The method of claim 1, wherein types of emission include at least one of:
NOx;
SOx;
ash;
CO;
CO₂;
mercury; and
particulate matter.

16. The method of claim 1, wherein the total emissions cost curve is indicative of an actual cost to produce power for a full range of megawatt outputs.

17. The method of claim 16, further comprising:
using the total emissions cost curve in conjunction with other cost curves receptive to providing an accurate cost to produce power for the full range of megawatt outputs.

18. One or more computer-readable media having computer-readable instructions thereon which, when executed by a computer, cause the computer to:
obtain current measurements from a respective sensor;
validate the current measurements;
generate a plurality of emission curves using predefined inputs for each load point, the plurality of emission curves including an emission design curve and a corresponding real time incremental emission curve;
validate each corresponding real time incremental emission curve and emission design curve to generate a validated emission curve; and
generate an incremental emission cost curve using each validated emission curve for each type of emission.

19. The one or more computer-readable media of claim 18, further causing the computer to:
sum each incremental emission cost curve to generate a total emissions cost curve if there is more than one incremental emission cost curve.

20. The one or more computer-readable media of claim 18, wherein the emission design curve is generated based on predefined inputs for emission at each megawatt load point and the corresponding real time incremental emission curve is generated over a full range of megawatt outputs by at least one of: offsetting the emission design curve with current emission measurements; using curve fitting based on historical data and the current measurements; artificial intelligence; and physics based models.

21. The one or more computer-readable media of claim 18, wherein the real time incremental emission curve is generated as the validated emission curve if valid and the emission design curve is generated as the validated emission curve if valid and the real time incremental emission curve is invalid.

22. The one or more computer-readable media of claim 18, wherein validation of the current measurements includes validating each emission load point against predefined tolerance bounds for that emission.

23. The one or more computer-readable media of claim 18, wherein the real time incremental emission curve is validated against the emission design curve by checking a trend of slopes for each curve.

24. The one or more computer-readable media of claim 23, wherein checking the trend of slopes for each curve includes creating curve fits for both curves and checking whether a sign of all higher order polynomial coefficients are the same.

25. The one or more computer-readable media of claim 18, wherein creating the real time incremental emission curve includes:
passing all inputs for a corresponding load point through an emissions module; and
generating a predicted value of emission for the corresponding load point for all load points in a selected megawatt load point range.

26. The one or more computer-readable media of claim 18, further causing the computer to:
use the total emissions cost curve in conjunction with other cost curves receptive to providing an accurate cost to produce power for a full range of megawatt outputs.

27. A system for generating emission curves over a range of load points comprising:
means for obtaining current measurements from a respective sensor;
means for validating the current measurements;
means for generating a plurality of emission curves using predefined inputs for each load point, the plurality of emission curves including an emission design curve and a corresponding real time incremental emission curve;
means for validating each corresponding real time incremental emission curve and emission design curve to generate a validated emission curve; and
means for generating an incremental emission cost curve using each validated emission curve for each type of emission.

28. The system of claim 27, further comprising:
means for summing each incremental emission cost curve to generate a total emissions cost curve if there is more than one incremental emission cost curve.

29. The system of claim 27, wherein the emission design curve is generated based on predefined inputs for emission at each megawatt load point and the corresponding real time incremental emission curve is generated over a full range of megawatt outputs by at least one of: offsetting the emission design curve with current emission measurements; using curve fitting based on historical data and the current measurements; artificial intelligence, and physics based models.

30. The system of claim 27, wherein the real time incremental emission curve is generated as the validated emission curve if valid and the emission design curve is generated as the validated emission curve if valid and the real time incremental emission curve is invalid.

31. The system of claim 27, wherein the real time incremental emission curve is created by:
passing all inputs for a corresponding load point through an emissions module; and
generating a predicted value of emission for the corresponding load point for all load points in a selected megawatt load point range.
